(19) United States
(12) Patent Application Publication
(10) Pub. No.: US 2025/0365783 A1
(43) Pub. Date: Nov. 27, 2025

(54) WIRELESS COMMUNICATION APPARATUS, WIRELESS COMMUNICATION METHOD, WIRELESS COMMUNICATION DEVICE, AND STORAGE MEDIUM

(71) Applicant: LUXSHARE PRECISION INDUSTRY COMPANY LIMITED, Baoan Shenzhen (CN)

(72) Inventors: Guan Hsiung WANG, Baoan Shenzhen (CN); Wei Hsin CHEN, Baoan Shenzhen (CN); Shih Wei WAN, Baoan Shenzhen (CN); Yi Chuan CHUNG, Baoan Shenzhen (CN); Chih-Wei WU, Baoan Shenzhen (CN); Yao Yuan CHANG, Baoan Shenzhen (CN)

(21) Appl. No.: 19/199,770

(22) Filed: May 6, 2025

(30) Foreign Application Priority Data
May 23, 2024 (CN) 2024106495694

(51) Int. Cl. H04W 76/10; H04W 88/08

(52) U.S. Cl. CPC H04W 76/10; H04W 88/08

(57) ABSTRACT

Wireless communication apparatus includes a wireless access point and a driving component. The wireless access point includes a plurality of angle indexes and a plurality of beacon power regions. The beacon power region where a current angle index of the plurality of angle indexes is located faces the wireless client-side apparatus which turns relative to the wireless access point after, and the wireless access point receives information of an angle to rotate generated by client-side wireless apparatus based on the included angle between the maximum beacon power region of the plurality of beacon power regions and the beacon power region corresponding to the current angle index. The wireless access point controls the driving component to drive the wireless access point to rotate by the angle to rotate according to the information of the angle to rotate so that the maximum beacon power region faces the wireless client-side apparatus.

### CROSS-REFERENCE TO RELATED APPLICATIONS

This application claims the priority benefit of Chinese Patent Application Serial Number 2024106495694, filed on May 23, 2024, the full disclosure of which is incorporated herein by reference.

### TECHNICAL FIELD OF THE INVENTION

The present disclosure is related to a technical field of communication device and is particularly related to wireless communication apparatus, a wireless communication method, a wireless communication device, and a storage medium.

### DESCRIPTION OF THE PRIOR ART

A wireless access point (AP) is an access point where wireless client-side apparatus enters a wired network. The position of the wireless access point after being ensured would not change, and the part of the wireless access point of which the signal strength is stronger faces the wireless client-side apparatus. In some cases, when there are variations in the orientation of the wireless client-side apparatus relative to the wireless access point, the orientation of the part of the wireless access point of which the signal strength is stronger relative to the wireless access point would also change instead of facing the wireless client-side apparatus so that the network connection status of the wireless client-side apparatus and the wireless access point become unstable.

Taking one example, when the wireless client-side apparatus is the wireless camera which a e-sports player wears, the wireless camera would follow the e-sports player to move together because the e-sports player is likely to walk back and forth for playing e-sports, and thus, the angle of view of the wireless access point and the wireless camera probably exhibits multiples paths and non-line of sight (NLOS). Because the walking of the e-sports player changes the orientation of the wireless camera relative to the wireless access point, the network connection status and the network throughput of the wireless client-side apparatus and the wireless access point would become very unstable.

Taking another example, when the wireless client-side apparatus is the wireless camera which an e-commerce anchor or a live anchor wears, the back and forth movement of the wireless camera would change the orientation of the wireless camera relative to the wireless camera because the anchor usually needs to carry the wireless camera to walk back and forth for capturing video and it is convenient for the anchor to explain and to interact with the audiences in front of screens, and thus, the stability of the network connection of the wireless client-side apparatus and the wireless access point would be deteriorated. Hence, when the orientation of the current wireless access point relative to the wireless client-side apparatus changes, there is a problem that the stability of the network connection of the wireless client-side apparatus and the wireless access point would be deteriorated.

### SUMMARY

The object of the present disclosure is to provide wireless communication apparatus which solves the problem that the stability of the network connection would be deteriorated due to the turning of the wireless client-side apparatus. The wireless communication apparatus communicates with the wireless client-side apparatus and includes a wireless access point and a driving component. The wireless access point includes a plurality of angle indexes and a plurality of beacon power regions corresponding to the plurality of angle indexes one on one, the beacon power region where a current angle index of the plurality of angle indexes is located faces the wireless client-side apparatus which turns relative to the wireless access point after, and the wireless access point is configured to receive information of an angle to rotate. The information of the angle to rotate is generated by the wireless client-side apparatus based on the included angle between a maximum beacon power region of the plurality of beacon power regions and the beacon power region where the current angle index is located. The wireless access point is disposed on the driving component, and the driving component is electrically connected to the wireless access point. The wireless access point controls the driving component to drive the wireless access point to rotate by an angle to rotate according to the information of the angle to rotate so that the maximum beacon power region faces the wireless client-side apparatus.

In some embodiments of the present disclosure, the wireless access point includes a SSID which provides foundation for the wireless access point to calculate the plurality of angle indexes.

In some embodiments of the present disclosure, the plurality of beacon power regions forms a circle.

In some embodiments of the present disclosure, the shape of the beacon power region is a circular sector, and the apex angle of the beacon power region is 45°.

In some embodiments of the present disclosure, the included angle between the angle bisector of the apex angle of the maximum beacon power region and the angle bisector of the apex angle of the beacon power region where the current angle index is located is the angle to rotate.

In some embodiments of the present disclosure, the driving component includes a base and a driving motor disposed on the base, and the wireless access point is disposed on and is electrically connected to the driving motor.

The present disclosure further provides a wireless communication method. The wireless communication method is performed by the wireless communication apparatus and includes steps as follows: receiving a packet of link rate information; determining whether the RSSI of the packet of the link rate information is greater than a first threshold value and determining whether the MCS rate of the packet of the link rate information is greater than a second threshold value; when determining that the RSSI of the packet of the link rate information is less than or equal to the first threshold value and the MCS rate of the packet of the link rate information is less than or equal to the second threshold value, transmitting a response packet to inform the wireless access point of rotation; generating the information of the angle to rotate.

In some embodiments of the present disclosure, the step of generating the information of the angle to rotate includes: obtaining the angle index of the maximum beacon power region; obtaining the current angle index; according to the angle index of the maximum beacon power region and the current angle index, setting the included angle between the maximum beacon power region and the beacon power region where the current angle index is located as the angle to rotate.

In some embodiments of the present disclosure, the step of obtaining the angle index of the maximum beacon power region includes: searching the SSID emitted by the wireless access point; capturing and recording each of the plurality of angle indexes of the frame of the SSID; measuring the beacon power corresponding to each of the plurality of angle indexes, and selecting the angle index of the maximum beacon power region.

The present disclosure further provides a wireless communication method. The wireless communication method is performed by the wireless communication apparatus and includes steps as follows: transmitting a packet of link rate information; determining whether to receive a response packet; when determining that the response packet is received, determining whether the response packet includes the information which informs the wireless access point of rotation; when determining that the response packet includes the information which informs the wireless access point of rotation, determining whether to receive the information of the angle to rotate; when determining that the information of the angle to rotate is received, controlling the driving component to drive the wireless access point to rotate by the angle to rotate according to the information of the angle to rotate.

The present disclosure further provides a wireless communication device. The wireless communication device includes a receiving unit, a first determination unit, a first transmission unit, and a generation unit. The receiving unit is configured to receive a packet of link rate information. The first determination unit is configured to determine whether the RSSI of the packet of the link rate information is greater than a first threshold value and to determine whether the MCS rate of the packet of the link rate information is greater than a second threshold value. The first transmission unit is configured to transmit a response packet to inform a wireless access point of rotation when the first determination unit determines that the RSSI of the packet of the link rate information is less than or equal to the first threshold value and the MCS rate of the packet of the link rate information is less than or equal to the second threshold value. The generation unit is configured to generate information of the angle to rotate.

In some embodiments of the present disclosure, the generation unit includes a first obtaining unit, a second obtaining unit, and a configuration unit. The first obtaining unit is configured to obtain the angle index of a maximum beacon power region. The second obtaining unit is configured to obtain a current angle index. The configuration unit is configured to set the included angle between the maximum beacon power region and the beacon power region where the current angle index is located as the angle to rotate according to the angle index of the maximum beacon power region and the current angle index.

In some embodiments of the present disclosure, the generation unit includes a searching unit, a capturing and recording unit, and a measuring unit. The searching unit is configured to search the SSID emitted by the wireless access point. The capturing and recording unit is configured to capture and record each of the plurality of angle indexes of the frame of the SSID. The measuring unit configured to measure the beacon power corresponding to each of the plurality of angle indexes and to select the angle index of the maximum beacon power region.

The present disclosure further provides a wireless communication device. The wireless communication device includes a second transmission unit, a second determination unit, a third determination unit, a fourth determination unit, and a control unit. The second transmission unit is configured to transmit a packet of link rate information. The second determination unit is configured to determine whether to receive a response packet. The third determination unit is configured to determine whether the response packet includes the information which informs a wireless access point of rotation when the second determination unit determines that the response packet is received. The fourth determination unit is configured to determine whether to receive information of an angle to rotate when the third determination unit determines that the response packet includes the information which informs the wireless access point of the rotation. The control unit is configured to control a driving component to drive the wireless access point to rotate by the angle to rotate according to the information of the angle to rotate when the fourth determination unit determines that the information of the angle to rotate is received.

The present disclosure further provides a storage medium storing a computer procedure. The aforementioned wireless communication method is implemented when the computer procedure is performed by a processor.

The beneficial effect of the present disclosure: the wireless access point and the driving component are disposed. The wireless access point includes the plurality of angle indexes and the plurality of beacon power regions corresponding to the plurality of angle indexes one on one, the beacon power region where the current angle index of the plurality of angle indexes is located faces the wireless client-side apparatus which turns relative to the wireless access point after, and the wireless access point is configured to receive the information of the angle to rotate. The information of the angle to rotate is generated by the wireless client-side apparatus based on the included angle between the maximum beacon power region of the plurality of beacon power regions and the beacon power region where the current angle index is located. The wireless access point is disposed on the driving component, and the driving component is electrically connected to the wireless access point. The wireless access point controls the driving component to drive the wireless access point to rotate by the angle to rotate according to the information of the angle to rotate so that the maximum beacon power region faces the wireless client-side apparatus.

Because the wireless access point may control the driving component to drive the wireless access point to rotate by the angle to rotate according to the information of the angle to rotate, the maximum beacon power region faces the wireless client-side apparatus. Hence, when the wireless client-side apparatus turns relative to the wireless access point, the wireless access point may follow the wireless client-side apparatus to rotate, and thus, the maximum beacon power region of the wireless access point always faces the wireless client-side apparatus and the stability of the network connection of the wireless client-side apparatus and the wireless access point would be maintained.

The aforementioned description of the present disclosure is merely the outline of the technical solutions of the present disclosure. In order to understand the technical solutions of the present disclosure clearly and to implement the present disclosure according to the content of the specification, the better embodiments of the present disclosure given herein below with accompanying drawings are used to describe the present disclosure in detail.

### BRIEF DESCRIPTION OF DRAWINGS

FIG. 1 depicts a 3D view diagram of wireless communication apparatus according to the first embodiment of the present disclosure.

FIG. 2 depicts a top view diagram of wireless communication apparatus (including wireless client-side apparatus) according to the first embodiment of the present disclosure.

FIG. 3 depicts a block diagram of wireless communication apparatus (including wireless client-side apparatus) according to the first embodiment of the present disclosure.

FIG. 4 depicts a flowchart of a wireless communication method according to the second embodiment of the present disclosure.

FIG. 5 depicts another flowchart of a wireless communication method according to the second embodiment of the present disclosure.

FIG. 6 depicts yet another flowchart of a wireless communication method according to the second embodiment of the present disclosure.

FIG. 7 depicts a flowchart of a wireless communication method according to the third embodiment of the present disclosure.

FIG. 8 depicts a block diagram of a wireless communication device according to the fourth embodiment of the present disclosure.

FIG. 9 depicts another block diagram of a wireless communication device according to the fourth embodiment of the present disclosure.

FIG. 10 depicts yet another block diagram of a wireless communication device according to the fourth embodiment of the present disclosure.

FIG. 11 depicts a block diagram of a wireless communication device according to the fifth embodiment of the present disclosure.

### DETAILED DESCRIPTION

The specific embodiments of the present disclosure given herein below is used to explain the implementation of the present disclosure. A person skilled in the art easily understands the advantages and the effects of the present disclosure from the content of the present disclosure.

It should be noted that the embodiments and the features in the embodiments of the present disclosure can be combined with each other without conflict. The present disclosure will be described in detail below with reference to accompanying drawings and in conjunction with the embodiments. In order to provide those in the art with better understanding of the solution of the disclosure, the technical solutions in the embodiments of the present disclosure will be described clearly and completely below in conjunction with the accompanying drawings in the embodiments of the present disclosure. Apparently, the described embodiments are merely one part of the embodiments of the present disclosure and not all embodiments of the present disclosure. Based on the embodiments of the present disclosure, all embodiments obtained by a person skilled in the art without any inventive steps shall fall within the scope of protection of the present disclosure.

It should be noted that the terms “first”, “second”, etc. in the specification and claims of the present disclosure and in the aforementioned accompanying drawings are used to distinguish similar objects and not used to describe a particular order or sequence. Furthermore, the terms “comprising” and “having”, and any variation thereof, are intended to encompass a non-exclusive inclusion, for example, a series of steps or units comprising processes, methods, systems, products or equipment do not need to be limited to those steps or units clearly listed but may include other steps or units not clearly listed or inherent to those processes, methods, products or equipment.

### The First Embodiment

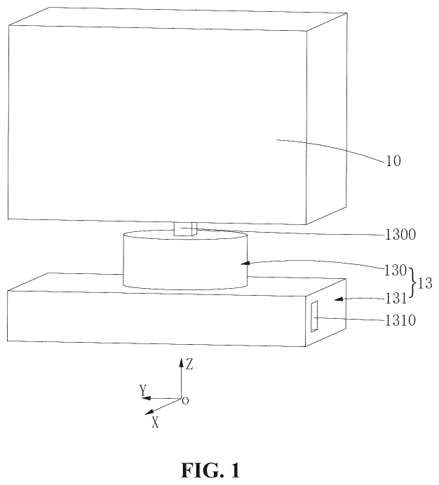

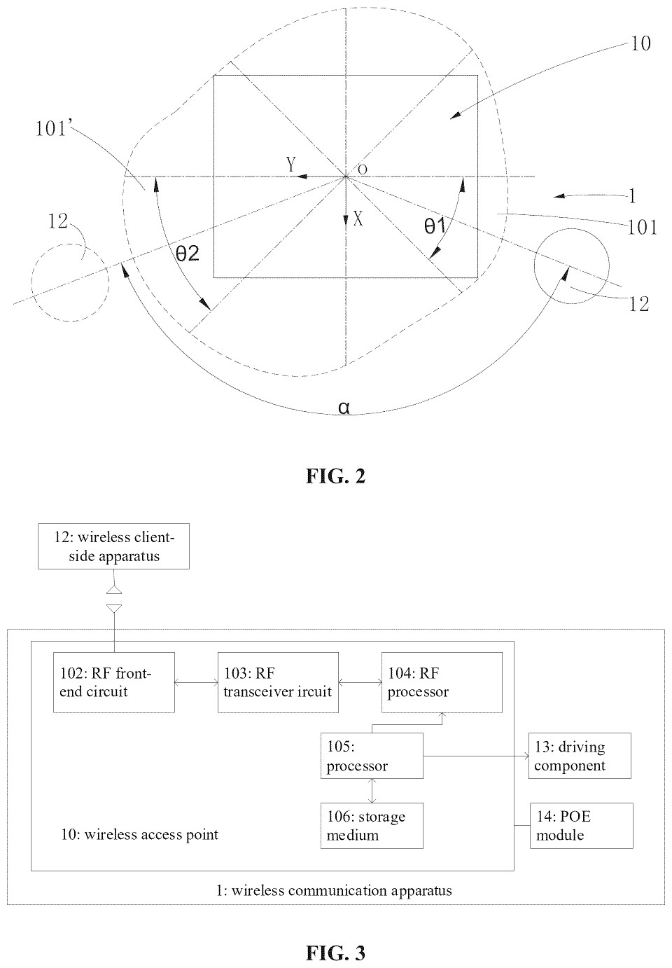

Please refer to FIG. 1 and FIG. 2, the present embodiment provides a wireless communication apparatus 1 for communicating with wireless client-side apparatus 12. The wireless communication apparatus 1 includes a wireless access point 10 and a driving component 13. The wireless access point 10 includes a plurality of angle indexes and a plurality of beacon power regions 101 corresponding to the plurality of angle indexes one on one. The beacon power region 101 where a current angle index of the plurality of angle indexes is located faces the wireless client-side apparatus 12 which turns relative to the wireless access point 10 after, and the wireless access point 10 is configured to receive information of an angle to rotate. The information of the angle to rotate is generated by the wireless client-side apparatus 12 based on the included angle between a maximum beacon power region 101′ of the plurality of beacon power regions and the beacon power region 101 where the current angle index is located. The wireless access point 10 is disposed on the driving component 13, and the driving component 13 is electrically connected to the wireless access point 10. The wireless access point 10 controls the driving component 13 to drive the wireless access point 10 to rotate by an angle to rotate a according to the information of the angle to rotate so that the maximum beacon power region 101′ faces the wireless client-side apparatus 12.

The wireless access point (Wireless AP) 10 is also known as a wireless base station and is the device in a computer network which connects a wireless network with a wired network (e.g., Ethernet). The wireless client-side apparatus 12 is electrically connected to the wireless access point 10. The wireless access point 10 is usually an individual device and is connected to a router by the wired network. The wireless access point 10 can also be integrated with the router. After the plurality of wireless access points 10 operate, one wireless access point 10 may be connected to another wireless access point 10 to form and expand the wireless network which transmits data. The wireless access point 10 also has the function of dynamic host configuration IP addresses of dynamic host configuration protocols (DHCPs).

As shown in FIG. 2, the distribution of the beacon power emitted outwardly by the wireless access point 10 shows an approximately spherical surface, and the cross section of the distribution of the beacon power which is the approximately spherical surface (the cross section may be the closed dotted loop in FIG. 2 which encompasses the wireless access point 10) is divided into the plurality of beacon power regions 101, and the corresponding beacon power of each beacon power region 101 would be various. The corresponding beacon power of each beacon power region 101 may be previously measured and be stored in the wireless access point 10 or the wireless client-side apparatus 12. The plurality of angle indexes may be disposed on the SSID of the wireless access point 10, and one angle index corresponds to one beacon power region 101. Thus, after the wireless client-side apparatus 12 obtains the angle index, the value of the beacon power of the beacon power region 101 corresponding to the angle index can be ensured.

The SSID is the abbreviation of Service Set Identifier. The plurality of angle indexes corresponds to the plurality of beacon power regions 101 one on one, i.e., each angle index labels one beacon power region 101. The SSID may be located inside the frame body of the data link layer of IEEE 802.11 standards and may continuously broadcast at regular intervals to provide its identifier. After the wireless client-side apparatus 12 searches the signal with the SSID periodically emitted by the wireless access point 10, the peak value of the power of the signal is the beacon power. The wireless client-side apparatus 12 may be electrically connected to the wireless access point 10 by wireless connection such as 2.4G and 5G.

As shown in FIG. 2, optionally, the wireless access point 10 includes the SSID which provides foundation for the wireless access point 10 to calculate the plurality of angle indexes. The plurality of beacon power regions 101 form a circle. Because the plurality of beacon power regions 101 forms a circle, the signals may be received in the circumferential direction of the wireless access point 10 without blind spots when the wireless client-side apparatus 12 rotates around the wireless access point 10. The shape of the beacon power region 101 is a circular sector, and the apex angle of the beacon power region 101 is 45°. The apexes of the apex angles of the plurality of beacon power regions 101 may overlap with each other so that the plurality of beacon power regions 101 form the circle. The plurality of beacon power regions 101 form the circle and the apex angle of each of the plurality of beacon power regions 101 is 45°, and it indicates that the number of the plurality of beacon power regions 101 is eight and the apex angles of the plurality of beacon power regions 101 are equal.

Please refer to FIG. 1 and FIG. 2. Optionally, the included angle between the angle bisector of the apex angle of the maximum beacon power region 101′ and the angle bisector of the apex angle of the beacon power region 101 where the current angle index is located is the angle to rotate a. The driving component 13 includes a base 131 and a driving motor 130 disposed on the base 131, and the wireless access point 10 is disposed on and is electrically connected to the driving motor 130. For example, the driving component 13 may be electrically connected to the wireless access point 10 by USB Type-C ports. The driving motor 130 may be fixed on the base 131 by screw connection or riveting connection. The structure of the base 131 is a cuboid.

Please refer to FIG. 1 and FIG. 2. The driving motor 130 may be disposed on the center of the upper side of the base 131. The driving motor 130 may be a stepper motor or a servo motor. The driving motor 130 includes an output shaft 1300, and the output shaft 1300 may be coaxially disposed with z-axis and is fixed on the bottom of the wireless access point 10. For example, the output shaft 1300 may be inserted into the bottom of the wireless access point 10 and is connected to the bottom of the wireless access point 10 by glue connection or key connection. The driving motor 130 may drive the wireless access point 10 to rotate around the z-axis. The base 131 may include a RJ-45 port 1310, and the RJ-45 port 1310 may be electrically connected to a Power over Ethernet (PoE) module 14 (the PoE module 14 may refer to FIG. 3, similarly hereinafter). In other words, the PoE module 14 provides electric power for the driving component 13. The PoE module 14 may be a PoE power supply. The RJ-45 port 1310 may be disposed on the right side of the base 131.

As shown in FIG. 1, the structure of the wireless access point 10 is the cuboid. For convenience to explain, Cartesian coordinate system O-xyz is created in the wireless access point 10. The axis which vertically passes through the upper surface and the lower surface of the wireless access point 10 and the center of the wireless access point 10 is the z-axis, x-axis is set to be parallel to the width direction of the wireless access point 10, and y-axis is set to be parallel to the length direction of the wireless access point 10. The beacon power region 101 may be the circular sector region of the circle plane parallel to XoY plane, i.e., the plurality of beacon power regions 101 may be merged as the circle plane. The apexes of the apex angles of the plurality of beacon power regions 101 may overlap with each other and be located on the z-axis.

As shown in FIG. 2, the number and the value of the area of the plurality of beacon power regions 101 may be preset on the wireless access point 10. The signals inside each of the plurality of beacon power regions 101 may be received by the wireless client-side apparatus 12 after outwardly propagating along the direction vertical to the z-axis. Because the distribution of the beacon power of the signals emitted by the wireless access point 10 is the approximately spherical surface and the high beacon power region on the approximately spherical surface of the distribution of the beacon power has larger projection on the plane parallel to the XoY plane, each circular sector region of the cross section of the distribution plane of the beacon power parallel to the XoY plane may serve as the beacon power region 101 corresponding to each angle index.

As shown in FIG. 3, the wireless access point 10 may include a RF front-end circuit 102, a RF transceiver circuit 103, a RF processor 104, a processor 105 and a storage medium 106. The RF front-end circuit 102, the RF transceiver circuit 103, the RF processor 104, the processor 105 and the storage medium 106 are electrically connected in order. The RF front-end circuit 102 and may be electrically connected to the wireless client-side apparatus 12 by the wireless connection such as 2.4G and 5G. The processor 105 is electrically connected to the driving component 13. For example, the processor 105 may be electrically connected to the driving component 13 by electric wires. The specific embodiment of the storage medium 106 may refer to the sixth embodiment.

The wireless client-side apparatus 12 may receive the plurality of angle indexes by the wireless connection. The wireless client-side apparatus 12 may be a wireless camera, a smart phone, a wireless microphone and so on. The wireless client-side apparatus 12 rotates around the axle line vertical to the beacon power region 101 relative to the wireless access point 10. For example, the turning of the wireless client-side apparatus 12 relative to the wireless access point 10 may be the rotation around the z-axis.

As shown in FIG. 2, taking eight angle indexes for example, how to generate the information of the angle to rotate by the wireless client-side apparatus 12 based on the included angle between the maximum beacon power region 101′ of the plurality of beacon power regions 101 and the beacon power region 101 where the current angle index is located would be explained. The included angle between the maximum beacon power region 101′ and the beacon power region 101 where the current angle index is located is the angle to rotate a. Each angle index corresponds to the circular sector region of which the apex angle is 45°, and the beacon power regions 101 of the eight angle indexes forms the circle.

As shown in FIG. 2, the wireless client-side apparatus 12 rotates relative to the wireless access point 10 to the beacon power region 101 where the current angle index is located. The apex angle of the beacon power region 101 where the current angle index is located is set as θ1, i.e., θ1=45°. The apex angle of the maximum beacon power region 101′ is set as θ2, i.e., θ2=45°. The initial position of the wireless client-side apparatus 12 may face θ2 (the wireless client-side apparatus 12 is expressed as the dotted line in FIG. 2), and the position of the wireless client-side apparatus 12 after turning may face θ1 (the wireless client-side apparatus 12 is expressed as the solid line in FIG. 2). Because the included angle between the maximum beacon power region 101′ and the beacon power region 101 where the current angle index is located may be the included angle between the angle bisector of θ1 and the angle bisector of θ2, and the number and the values of the apex angles of the beacon power regions 101 between θ1 and θ2 are also known, the included angle between the angle bisector of θ1 and the angle bisector of θ2 may be ensured by the sum of the apex angles corresponding to the beacon power regions 101 between θ1 and θ2.

As shown in FIG. 2, for example, there are two beacon power regions 101 between θ1 and θ2, the apex angle of each beacon power region 101 is 45°, and the included angle between the angle bisector of θ1 and the angle bisector of θ2 is 135° (135°=θ½+2×45°+θ2/2); in other words, the angle to rotate a is 135°. Hence, the wireless client-side apparatus 12 may be redirected to the maximum beacon power region 101′ in the wireless access point 10 after the wireless access point 10 merely has to control the driving component 13 (the driving component 13 may refer to FIG. 1, similarly hereinafter) to rotate by 135°. For example, the wireless access point 10 may control the output shaft 1300 (the output shaft 1300 may refer to FIG. 1) of the driving component 13 to rotate around the z-axis by 135° in an anticlockwise direction. Taking the wireless camera which the e-commerce anchor uses during live stream as an example of the wireless client-side apparatus 12, the direction of the wireless camera which the e-commerce anchor wears relative to the wireless access point 10 continuously changes because the e-commerce anchor would not stop walking.

When the e-commerce anchor walks toward the beacon power region 101 corresponding to θ1, the connection rate of the wireless camera and the wireless access point 10 would decrease because the beacon power region 101 which the e-commerce anchor faces is not the beacon power region 101′ corresponding to θ2 (the beacon power region 101′ corresponding to θ2 is the maximum beacon power region 101′). The wireless access point 10 at present may rotate the included angle between the angle bisector of θ1 and the angle bisector of θ2 (i.e., rotate 135°) so that the beacon power region 101′ corresponding to θ2 faces the e-commerce anchor. When the wireless client-side apparatus 12 is the wireless camera of the e-sports player, the turning process of the wireless access point 10 connected to wireless camera of the e-sports player and the turning process of the wireless access point 10 connected to the wireless camera of the e-commerce anchor uses during live stream are similar.

In the above description, the case that the values of the apex angles of the beacon power region 101 where the plurality of angle indexes are located are equal is merely as an example, and the case that the values of the apex angles of the beacon power region 101 where the plurality of angle indexes are located are not equal is similar to the aforementioned example. Because the number and the values of the apex angles of the beacon power regions 101 corresponding to the plurality of angle indexes are preset and stored on the wireless access point 10, the sum of the apex angles of the arbitrary number of the angle indexes in the entire angle indexes may also be calculated. In other words, the included angle between the maximum beacon power region 101′ and the beacon power region 101 where the current angle index is located may be calculated by the number of the beacon power regions 101 between the maximum beacon power region 101′ and the beacon power region 101 where the current angle index is located and the values of the apex angles of the beacon power regions 101.

Because the wireless access point 10 may control the driving component 13 to drive the wireless access point 10 to rotate by the angle to rotate a according to the information of the angle to rotate, the maximum beacon power region 101′ faces the wireless client-side apparatus 12. Hence, when the wireless client-side apparatus 12 turns relative to the wireless access point 10, the wireless access point 10 may follow the wireless client-side apparatus 12 to rotate, and thus, the maximum beacon power region 101′ of the wireless access point always 10 faces the wireless client-side apparatus 12 and the stability of the network connection of the wireless client-side apparatus 12 and the wireless access point 10 would be maintained.

### The Second Embodiment

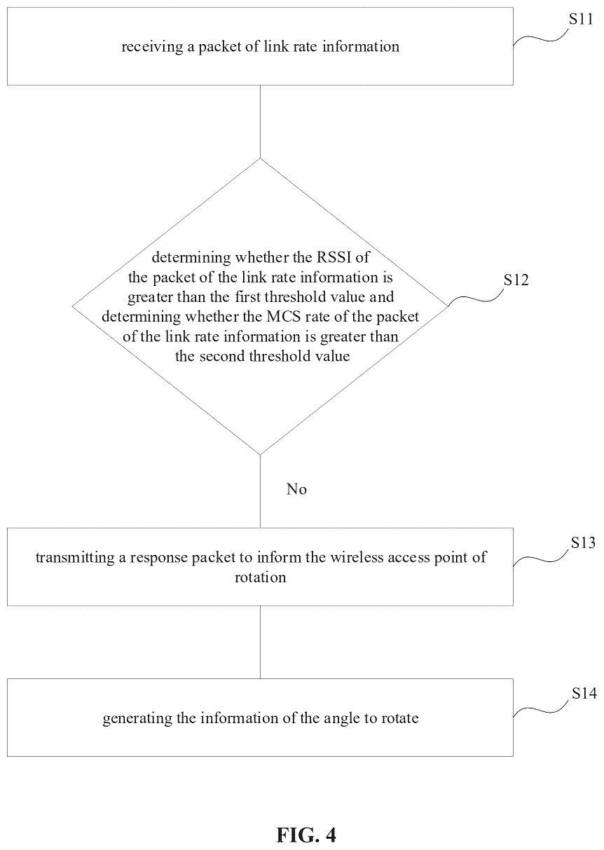

As shown in FIG. 4, the present embodiment provides a wireless communication method performed by the wireless client-side apparatus 12 in the first embodiment (the wireless communication apparatus 1 and the wireless client-side apparatus 12 may refer to FIG. 2, similarly hereinafter) includes steps as follows:

Step S11: receiving a packet of link rate information. The wireless client-side apparatus 12 may periodically receive the packet of link rate information emitted from the wireless access point 10 (the wireless access point 10 may refer to FIG. 2, similarly hereinafter) by the wireless connection (e.g., 2.4G or 5G).

Step S12: determining whether the RSSI of the packet of the link rate information is greater than the first threshold value and determining whether the MCS rate of the packet of the link rate information is greater than the second threshold value. The RSSI is the abbreviation of Received Signal Strength Indication, and the MCS is the abbreviation of Modulation and Coding Scheme. The normal value of the RSSI depends on specific wireless communication standards and application environments. For example, in a Wi-Fi network, the value of the RSSI of 60 dBm to −80 dBm is regarded as great signal quality, and the value of the RSSI less than −90 dBm is regarded as poor signal quality and may results in slow network speed or lost network connection. The first threshold value may be 80 dBm, and the second threshold value may be −80 dBm.

By determining whether the RSSI is greater than the first threshold value, the wireless access point 10 may analyze whether the channel state information (CSI) of the TX stream from the wireless client-side apparatus 12 to the wireless access point 10 is well connected or whether the channel state information (CSI) of the TX stream from the wireless client-side apparatus 12 to the wireless access point 10 is to encounter multiple reflections. In addition, the wireless access point 10 may determine the MCS rate according to the network connection status of the CSI and further determine a maximum throughput in theory.

Step S13: when determining that the RSSI of the packet of the link rate information is less than or equal to the first threshold value and the MCS rate of the packet of the link rate information is less than or equal to the second threshold value, transmitting a response packet to inform the wireless access point 10 of rotation. The timing when the wireless access point 10 needs to rotate is the time point when the maximum beacon power region 101′ on the wireless access point 10 does not face the wireless client-side apparatus 12. In comparison with the network connection rate of the wireless access point 10 and the wireless client-side apparatus 12 when the maximum beacon power region 101′ faces the wireless client-side apparatus 12, the network connection rate of the wireless access point 10 and the wireless client-side apparatus 12 when the maximum beacon power region 101′ on the wireless access point 10 does not face the wireless client-side apparatus 12 would decrease, and the network connection of the wireless access point 10 and the wireless client-side apparatus 12 when the maximum beacon power region 101′ on the wireless access point 10 does not face the wireless client-side apparatus 12 become unstable; at present, it indicates that the wireless access point 10 needs to rotate.

Step S14: generating the information of the angle to rotate. The information of the angle to rotate is the information including the angle to rotate a. The information of the angle to rotate may be used in the latter step of transmitting the information of the angle to rotate to the wireless access point 10.

The link rate is a physical layer rate (PHY rate). The link rate may be the maximum theoretical transmission rate of the wireless link between the wireless client-side apparatus 12 and the wireless access point 10 in theory. The PHY rate is 300 Mbps when communication protocol is IEEE 802.11n and a mode is 2×2 40 MHz, and the PHY rate when corresponding to TCP/IP layer is approximately 180 Mbps. The PHY rate is directly related to the wireless signal strength. When the wireless client-side apparatus 12 approaches the wireless access point 1, the wireless signal strength is maximum (100% or nearly 100%). When the distance between the wireless client-side apparatus 12 and a reference position changes from a LOS distance to a NLOS distance, the PHY rate would change accordingly. When the wireless client-side apparatus 12 moves relative to the wireless access point 10 at different angles, there are different variations on the PHY rate.

The wireless client-side apparatus 12 includes a wireless client-side apparatus processor, and the wireless client-side apparatus processor may perform step S11-step S14 in the wireless communication method when performing a computer procedure.

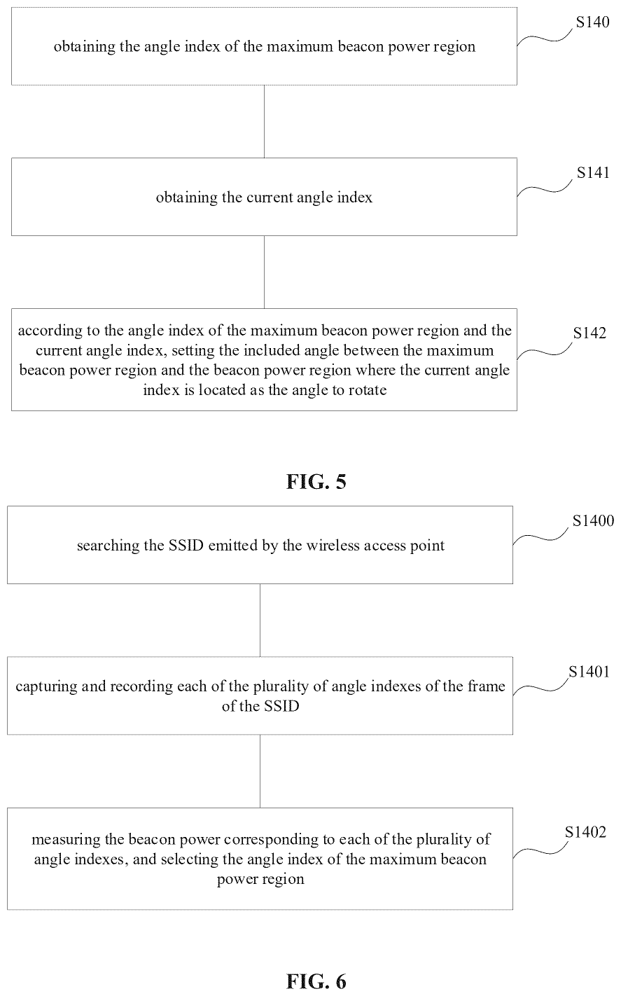

Optionally, as shown in FIG. 5, step S14 includes:

Step S140: obtaining the angle index of the maximum beacon power region 101′.

Step S141: obtaining the current angle index. After the wireless access point 10 turns from the initial position, one beacon power region 101 of the wireless access point 10 would face the wireless client-side apparatus 12, and the beacon power region 101 which faces the wireless client-side apparatus 12 is the beacon power region 101 where the current angle index is located.

Step S142: according to the angle index of the maximum beacon power region 101′ and the current angle index, setting the included angle between the maximum beacon power region 101′ and the beacon power region 101 where the current angle index is located as the angle to rotate a. The maximum beacon power region 101′ and the beacon power region 101 where the current angle index is located may be the circular sector regions. The angle to rotate a is the included angle between the angle bisector of the apex angle of the maximum beacon power region 101′ and the angle bisector of the apex angle of the beacon power region 101 where the current angle index is located.

The wireless client-side apparatus 12 includes a wireless client-side apparatus processor, and the wireless client-side apparatus processor may perform step S140-step S142 in the wireless communication method when performing the computer procedure.

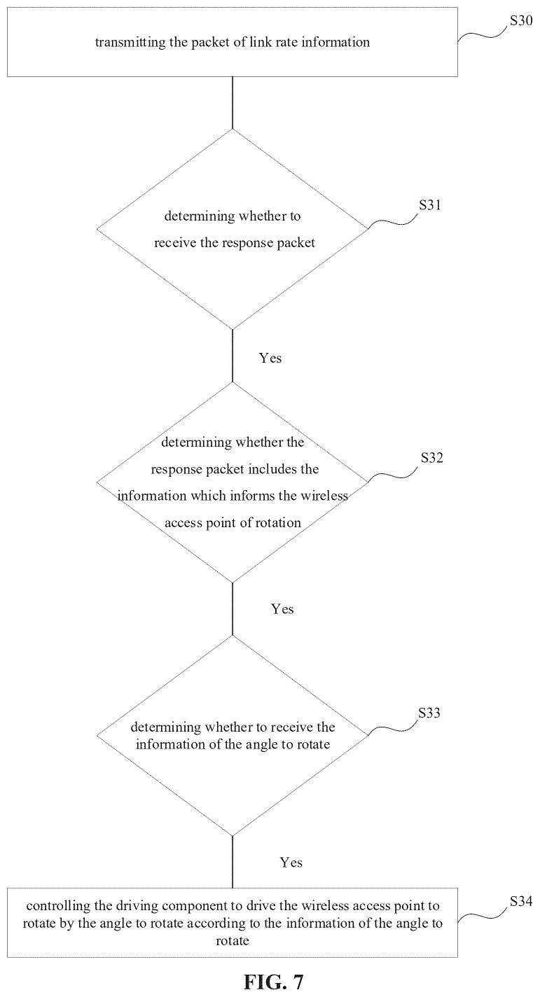

Optionally, as shown in FIG. 6, step S140 includes:

Step S1400: searching the SSID emitted by the wireless access point 10.

Step S1401: capturing and recording each of the plurality of angle indexes of the frame of the SSID.

Step S1402: measuring the beacon power corresponding to each of the plurality of angle indexes, and selecting the angle index of the maximum beacon power region 101′.

The wireless client-side apparatus 12 includes a wireless client-side apparatus processor, and the wireless client-side apparatus processor may perform step S1400-step S1402 in the wireless communication method when performing the computer procedure.

### The Third Embodiment

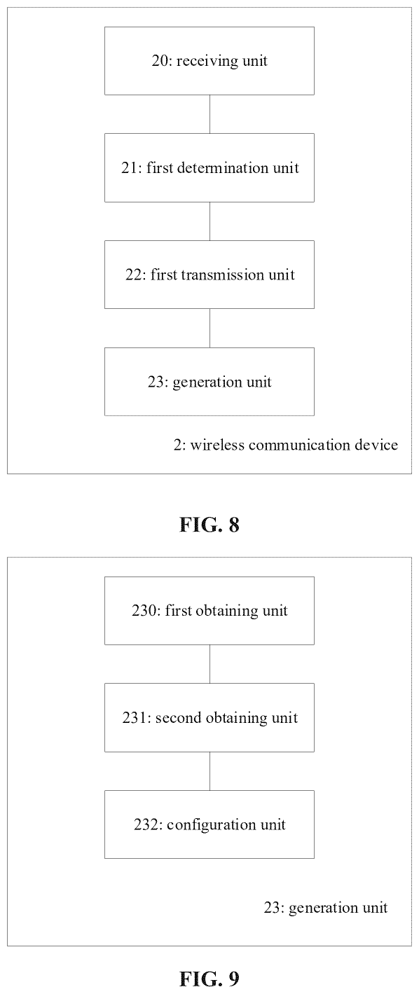

As shown in FIG. 7, the present embodiment provides a wireless communication method performed by the wireless access point 10 (the wireless access point 10 may refer to FIG. 2, similarly hereinafter) of the wireless communication apparatus 1 in the first embodiment includes steps as follows:

Step S30: transmitting the packet of link rate information. The packet of link rate information may be transmitted to the wireless client-side apparatus 12 (the wireless client-side apparatus 12 may refer to FIG. 2, similarly hereinafter). The wireless access point 10 may periodically transmit the packet of link rate information to the wireless client-side apparatus 12 by the wireless connection (e.g., 2.4G or 5G).

Step S31: determining whether to receive the response packet. The response packet may come from the wireless client-side apparatus 12, i.e., the wireless access point 10 may determine whether to receive the response packet from the wireless client-side apparatus 12.

Step S32: when determining that the response packet is received, determining whether the response packet includes the information which informs the wireless access point 10 of rotation.

Step S33: when determining that the response packet includes the information which informs the wireless access point 10 of rotation, determining whether to receive the information of the angle to rotate. The information of the angle to rotate may be generated by the wireless client-side apparatus 12 and be transmitted to the wireless access point 10.

Step S34: when determining that the information of the angle to rotate is received, controlling the driving component 13 to drive the wireless access point 10 to rotate by the angle to rotate a according to the information of the angle to rotate. The information of the angle to rotate may be generated by step S14 in the second embodiment. The wireless access point 10 may control the output shaft 1300 of the driving component 13 to rotate around the z-axis by the angle to rotate a, thus driving the wireless access point 10 to rotate around the z-axis.

The wireless access point 10 includes the processor 105 (the processor 105 may refer to FIG. 3, similarly hereinafter), and the processor 105 may perform step S30-step S34 in the wireless communication method when performing the computer procedure.

### The Fourth Embodiment

As shown in FIG. 8, the present embodiment provides a wireless communication device 2, and the wireless communication device 2 includes a receiving unit 20, a first determination unit 21, a first transmission unit 22 and a generation unit 23. The receiving unit 20 is configured to receive the packet of link rate information. The first determination unit 21 is configured to determine whether the RSSI of the packet of the link rate information is greater than the first threshold value and to determine whether the MCS rate of the packet of the link rate information is greater than the second threshold value. The first transmission unit 22 is configured to transmit the response packet to inform the wireless access point 10 of rotation when the first determination unit 21 determines that the RSSI of the packet of the link rate information is less than or equal to the first threshold value and the MCS rate of the packet of the link rate information is less than or equal to the second threshold value. The generation unit 23 is configured to generate the information of the angle to rotate. The first threshold value may be −80 dBm, and the second threshold value may be 80 dBm.

As shown in FIG. 9, optionally, the generation unit 23 includes a first obtaining unit 230, a second obtaining unit 231 and a configuration unit 232. The first obtaining unit 230 is configured to obtain the angle index of the maximum beacon power region 101′. The second obtaining unit 231 is configured to obtain the current angle index. The configuration unit 232 is configured to set the included angle between the maximum beacon power region 101′ and the beacon power region 101 where the current angle index is located as the angle to rotate a according to the angle index of the maximum beacon power region 101′ and the current angle index.

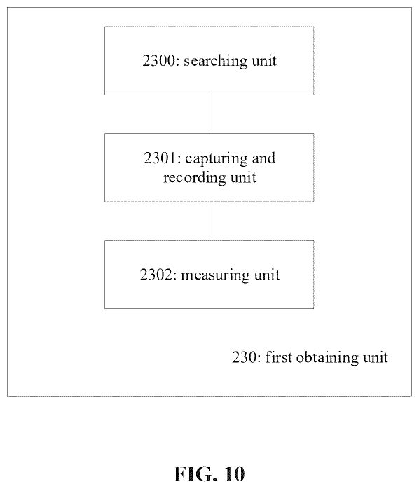

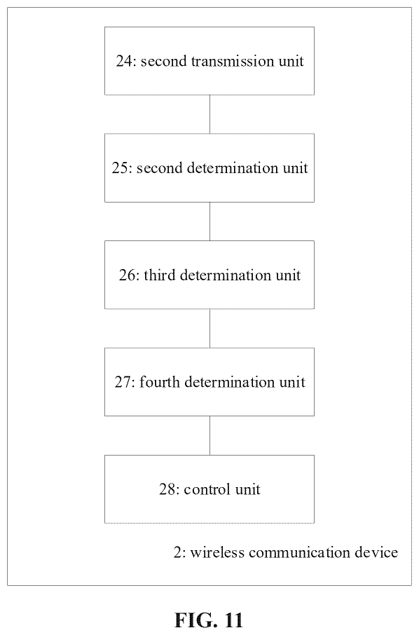

As shown in FIG. 10, optionally, the first obtaining unit 230 includes a searching unit 2300, a capturing and recording unit 2301 and a measuring unit 2302. The searching unit 2300 is configured to search the SSID emitted by the wireless access point 10. The capturing and recording unit 2301 is configured to capture and record each of the plurality of angle indexes of the frame of the SSID. The measuring unit 2302 is configured to measure the beacon power corresponding to each of the plurality of angle indexes and to select the angle index of the maximum beacon power region 101′.

### The Fifth Embodiment

As shown in FIG. 8, the present embodiment provides the wireless communication device 2, and the wireless communication device 2 includes a second transmission unit 24, a second determination unit 25, a third determination unit 26, a fourth determination unit 27 and a control unit 28. The second transmission unit 24 is configured to transmit the packet of link rate information. The second determination unit 25 is configured to determine whether to receive the response packet. The third determination unit 26 is configured to determine whether the response packet includes the information which informs the wireless access point 10 of rotation when the second determination unit 25 determines that the response packet is received. The wireless access point 10 may refer to FIG. 2, similarly hereinafter. The fourth determination unit 27 is configured to determine whether to receive the information of the angle to rotate when the third determination unit 26 determines that the response packet includes the information which informs the wireless access point 10 of rotation. The control unit 28 is configured to control the driving component 13 to drive the wireless access point 10 to rotate by the angle to rotate a according to the information of the angle to rotate when the fourth determination unit 27 determines that the information of the angle to rotate is received. The driving component 13 may refer to FIG. 1, and the angle to rotate a may refer to FIG. 2.

### The Sixth Embodiment

The present embodiment provides a storage medium 106, the storage medium 106 stores a computer procedure, and the wireless communication methods in the second embodiment and the third embodiment are implemented when the computer procedure is performed by the processor 105. The storage medium 106 and the processor 105 may refer to FIG. 3. The processor 105 is electrically connected to the storage medium 106, and the specific electric connection between the processor 105 and the storage medium 106 may refer to the first embodiment. The storage medium 106 may be a RAM, a ROM, EEPROM, a CDROM, a SSD, the other CD storage device, a disk storage device or the other magnetic storage device, a flash memory or any other medium which may be configured to store needed program codes in the form of commands or data structures and may be accessed by a computer.

What is claimed is:

1. Wireless communication apparatus for communicating with wireless client-side apparatus comprising:
a wireless access point comprising a plurality of angle indexes and a plurality of beacon power regions corresponding to the plurality of angle indexes one on one, wherein the beacon power region where a current angle index of the plurality of angle indexes is located faces the wireless client-side apparatus which turns relative to the wireless access point after, the wireless access point is configured to receive information of an angle to rotate, and the information of the angle to rotate is generated by the wireless client-side apparatus based on an included angle between a maximum beacon power region of the plurality of beacon power regions and the beacon power region where the current angle index is located; and
a driving component electrically connected to the wireless access point, wherein the wireless access point is disposed on the driving component and controls the driving component to drive the wireless access point to rotate by the angle to rotate according to the information of the angle to rotate so that the maximum beacon power region faces the wireless client-side apparatus.

2. The wireless communication apparatus according to claim 1, wherein the wireless access point comprises a SSID which provides foundation for the wireless access point to calculate the plurality of angle indexes.

3. The wireless communication apparatus according to claim 1, wherein the plurality of beacon power regions form a circle.

4. The wireless communication apparatus according to claim 3, wherein a shape of the beacon power region is a circular sector, and an apex angle of the beacon power region is 45°.

5. The wireless communication apparatus according to claim 1, wherein the included angle between an angle bisector of an apex angle of the maximum beacon power region and an angle bisector of an apex angle of the beacon power region where the current angle index is located is the angle to rotate.

6. The wireless communication apparatus according to claim 1, wherein the driving component comprises a base and a driving motor disposed on the base, and the wireless access point is disposed on and is electrically connected to the driving motor.

7. A wireless communication method performed by the wireless communication apparatus according to claim 1, the wireless communication method comprising steps as follows:
receiving a packet of link rate information;
determining whether a RSSI of the packet of the link rate information is greater than a first threshold value and determining whether a MCS rate of the packet of the link rate information is greater than a second threshold value;
when determining that the RSSI of the packet of the link rate information is less than or equal to the first threshold value and the MCS rate of the packet of the link rate information is less than or equal to the second threshold value, transmitting a response packet to inform the wireless access point of rotation; and
generating the information of the angle to rotate.

8. The wireless communication method according to claim 7, wherein the step of generating the information of the angle to rotate comprises:
obtaining the angle index of the maximum beacon power region;
obtaining the current angle index; and
according to the angle index of the maximum beacon power region and the current angle index, setting the included angle between the maximum beacon power region and the beacon power region where the current angle index is located as the angle to rotate.

9. The wireless communication method according to claim 8, wherein the step of obtaining the angle index of the maximum beacon power region comprises:
searching a SSID emitted by the wireless access point;
capturing and recording each of the plurality of angle indexes of a frame of the SSID;
measuring beacon power corresponding to each of the plurality of angle indexes, and selecting the angle index of the maximum beacon power region.

10. A wireless communication method performed by the wireless access point in the wireless communication apparatus according to claim 1 comprising:
transmitting a packet of link rate information;
determining whether to receive a response packet;
when determining that the response packet is received, determining whether the response packet comprises information which informs the wireless access point of rotation;
when determining that the response packet comprises the information which informs the wireless access point of the rotation, determining whether to receive the information of the angle to rotate;
when determining that the information of the angle to rotate is received, controlling the driving component to drive the wireless access point to rotate by the angle to rotate according to the information of the angle to rotate.

11. A wireless communication device comprising:
a receiving unit configured to receive a packet of link rate information;
a first determination unit configured to determine whether a RSSI of the packet of the link rate information is greater than a first threshold value and to determine whether a MCS rate of the packet of the link rate information is greater than a second threshold value;
a first transmission unit configured to transmit a response packet to inform a wireless access point of rotation when the first determination unit determines that the RSSI of the packet of the link rate information is less than or equal to the first threshold value and the MCS rate of the packet of the link rate information is less than or equal to the second threshold value; and
a generation unit configured to generate information of an angle to rotate.

12. The wireless communication device according to claim 11, wherein the generation unit comprises:
a first obtaining unit configured to obtain an angle index of a maximum beacon power region;
a second obtaining unit configured to obtain a current angle index; and
a configuration unit configured to set an included angle between the maximum beacon power region and a beacon power region where the current angle index is located as the angle to rotate according to the angle index of the maximum beacon power region and the current angle index.

13. The wireless communication device according to claim 12, wherein the first obtaining unit comprises:
a searching unit configured to search a SSID emitted by the wireless access point;
a capturing and recording unit configured to capture and record each of the plurality of angle indexes of a frame of the SSID;
a measuring unit configured to measure beacon power corresponding to each of the plurality of angle indexes and to select the angle index of the maximum beacon power region.

14. A wireless communication device comprising:
a second transmission unit configured to transmit a packet of link rate information;
a second determination unit configured to determine whether to receive a response packet;
a third determination unit configured to determine whether the response packet comprises information which informs a wireless access point of rotation when the second determination unit determines that the response packet is received;
a fourth determination unit configured to determine whether to receive information of an angle to rotate when the third determination unit determines that the response packet comprises information which informs the wireless access point of the rotation; and
a control unit configured to control a driving component to drive the wireless access point to rotate by the angle to rotate according to the information of the angle to rotate when the fourth determination unit determines that the information of the angle to rotate is received.

15. A storage medium storing a computer procedure, wherein the wireless communication method according to claim 7 is implemented when the computer procedure is performed by a processor.
